(19) United States
(12) Patent Application Publication
(10) Pub. No.: US 2008/0226541 A1
(43) Pub. Date: Sep. 18, 2008

(54) Recovery of Aqueous Hydrogen Peroxide in Auto-Oxidation H2O2 Production

(75) Inventors: Xinliang Zhou, Sugar Land, TX (US); Kevin Hammack, League City, TX (US); Dalbir S. Sethi, Cranbury, NJ (US)

Correspondence Address: PATENT ADMINISTRATOR;FMC CORPORATION, 1735 MARKET STREET, PHILADELPHIA, PA, 19103, US

(73) Assignee: FMC Corporation, Philadelphia, PA (US)

(21) Appl. No.: 12/048,907

(22) Filed: Mar. 14, 2008

Related U.S. Application Data
(60) Provisional application No. 60/918,087, filed on Mar. 15, 2007.

(51) Int. Cl. C01B 15/023; C01B 15/022

(52) U.S. Cl. 423/588; 423/587

(57) ABSTRACT

Hydrogen peroxide produced in an auto-oxidation process is recovered from H₂O₂-containing organic solution via liquid-liquid extraction with an aqueous medium in a device having elongated channels, with a small cross-sectional dimension, that facilitate efficient extraction of aqueous hydrogen peroxide from the organic solution.

### PRIORITY INFORMATION

This application claims the benefit of U.S. Provisional Application No. 60/918,087, filed Mar. 15, 2007.

### FIELD OF THE INVENTION

The present invention relates to an improved method for recovering hydrogen peroxide in an auto-oxidation process. More particularly, the invention relates to an efficient method for the aqueous liquid-liquid extraction of hydrogen peroxide from H₂O₂-containing work solution in a H₂O₂ anthraquinone auto-oxidation process.

### BACKGROUND OF THE INVENTION

Hydrogen peroxide (H₂O₂) is a versatile commodity chemical with diverse applications. Hydrogen peroxide's applications take advantage of its strong oxidizing agent properties and include pulp/paper bleaching, waste water treatment, chemical synthesis, textile bleaching, metals processing, microelectronics production, food packaging, health care and cosmetics applications. The annual U.S. production of H₂O₂ is 1.7 billion pounds, which represents roughly 30% of the total world output of 5.9 billion pounds per year. The worldwide market for hydrogen peroxide is expected to grow steadily at about 3% annually.

Hydrogen peroxide may be manufactured on a commercial scale by various chemical processes. The most significant of these chemical processes involves production of hydrogen peroxide from hydrogen and oxygen in the auto-oxidation (AO) of a “working compound” or “working reactant” or “reactive compound”, usually carried in a solvent-containing “work solution”. Commercial AO manufacture of hydrogen peroxide has utilized working compounds in both cyclic and non-cyclic processes.

In cyclic AO processes for the production of hydrogen peroxide, the working compound in the work solution is first hydrogenated, typically with hydrogen gas in the presence of a catalyst such as palladium or nickel. The hydrogenated work solution is then subjected to an oxidation step, using air or oxygen or oxygen-enriched gas, in an auto-oxidation reaction that results in the formation of hydrogen peroxide. The resulting hydrogen peroxide remains dissolved in the auto-oxidized organic solution and is present at relatively dilute concentrations, e.g. at least about 0.3 wt % H₂O₂

Most current large-scale hydrogen peroxide manufacturing processes are based on an anthraquinone AO process, in which hydrogen peroxide is formed by a cyclic reduction and subsequent auto-oxidation of anthraquinone derivatives. The anthraquinone auto-oxidation process for the manufacture of hydrogen peroxide is well known, being disclosed in the 1930s by Riedl and Pfleiderer, e.g., in U.S. Pat. No. 2,158,525 and No. 2,215,883. An overview of the anthraquinone AO process for the production of hydrogen peroxide is given in the Kirk-Othmer Encyclopedia of Chemical Technology, 3rd. ed., Volume 13, Wiley, N.Y., 2001, pp. 6-15 and Ullman's Encyclopedia of Industrial Chemistry, 5^{th} Edition, 1991, Volume A 13, pages 443-467.

In addition to the anthraquinones, examples of other working compounds feasible for use in the cyclic auto-oxidation manufacture of hydrogen peroxide include azobenzene and phenazine; see, e.g. U.S. Pat. No. 2,035,101, U.S. Pat. No. 2,862,794 and Kirk-Othmer Encyclopedia of Chemical Technology, Volume 13, Wiley, N.Y., 2001981, p. 6.

In commercial AO hydrogen peroxide processes, the anthraquinone derivatives (i.e., the working compounds) are usually alkyl anthraquinones and/or alkyl tetrahydroanthraquinones, and these are used as the working compound(s) in a solvent-containing work solution. The anthraquinone derivatives are dissolved in an inert solvent system that is based on organic solvents. This mixture of working compounds and organic solvent(s) is called the work solution and is the cycling fluid of the AO process. The organic solvent components are normally selected based on their ability to dissolve anthraquinones and anthrahydroquinones, but other important solvent criteria are low vapor pressure, relatively high flash point, low water solubility and favorable water extraction characteristics.

Non-cyclic AO hydrogen peroxide processes typically involve the auto-oxidation of a working compound, without an initial reduction of hydrogenation step, as in the auto-oxidation of isopropanol or other primary or secondary alcohol to an aldehyde or ketone, to yield hydrogen peroxide.

Hydrogenation (reduction) of the anthraquinone-containing work solution is carried out by contact of the latter with a hydrogen-containing gas in the presence of a palladium or nickel catalyst in a large scale reactor at elevated temperature, e.g., about 40-80° C., to produce anthrahydroquinones. Once the hydrogenation reaction has reached the desired degree of completion, the hydrogenated work solution is removed from the hydrogenation reactor and is then subjected to an oxidation step.

The oxidation of anthrahydroquinones-containing work solution is carried out in an oxidation reactor by contact with an oxygen-containing gas, usually air, and is normally carried out at a temperature in the range of about 30-70° C. The oxidation step converts the anthrahydroquinones back to anthraquinones and simultaneously forms H₂O₂ which normally remains dissolved in the organic work solution. Typical concentrations of hydrogen peroxide in the work solution may range from about 0.5 wt % H₂O₂ to about 2 wt % H₂O₂.

The remaining steps in conventional AO processes are physical unit operations directed to recovery of the hydrogen peroxide product from the organic work solution, the subsequent concentration and purification of the aqueous hydrogen peroxide product, and recycle of the H₂O₂-depleted work solution for reuse.

The H₂O₂ produced in the work solution during the oxidation step is normally separated from the work solution in an extraction step, usually with water. The work solution from which H₂O₂ has been extracted is returned to the reduction (hydrogenation) step. Thus, the hydrogenation-oxidation-extraction cycle is carried out in a continuous loop, i.e., as a cyclic operation. The H₂O₂ leaving the extraction step, in commercial practice using multistage extraction devices, normally contains at least 20 wt % H₂O₂ and is typically purified and concentrated further.

Commercial AO processes typically carry out the extraction step using large multistage extraction columns, in which the aqueous extraction medium (usually water) is contacted in multiple stages with the H₂O₂-containing work solution, in countercurrent flow streams. The work solution is normally less dense than the water used to extract the hydrogen peroxide, so the work solution is introduced at the base of the column and the water at the top. The most commonly used column is a sieve tray or sieve plate column, but spray columns and packed columns (e.g., with saddle or ring packing) have also been described for use in the liquid-liquid extraction of hydrogen peroxide from the work solution.

Sieve tray extraction columns have the advantage of high throughput and good tray efficiency; furthermore, they have no moving parts and are economical to maintain. However, such extraction columns represent a significant capital investment, since large scale AO processes require extraction columns that can be at least 90 ft tall with a diameter of at least 10 ft, having dozens of sieve plates (stages). In addition, sieve tray and other analogous extraction columns typically only achieve about 20-50% of theoretical equilibrium (of hydrogen peroxide distribution from the work solution into the aqueous phase) in each of the sieve trays (plates), a factor that accounts for the large number of trays or plates (i.e., stages) employed in these columns.

It is a principal object of this invention to provide an improved method for the liquid-liquid extraction of aqueous hydrogen peroxide from an organic solution containing hydrogen peroxide, in an extraction device that is more efficient in extractive mass transfer than conventional sieve tray columns and is potentially less costly than such columns.

The present invention achieves these and other objectives in the auto-oxidation production of hydrogen peroxide, in a liquid-liquid extraction carried out in an extraction device having small-dimension elongated channels that enhance the extractive mass transfer of the hydrogen peroxide from the organic phase (work solution) into the aqueous extract.

### SUMMARY OF THE INVENTION

In accordance with the present invention, hydrogen peroxide produced in an auto-oxidation process is recovered in a method comprising contacting a H₂O₂-containing organic solution in an auto-oxidation process with an aqueous extraction medium in a device with elongated channels having at least one cross sectional dimension within the range of from about 5 microns to about 5 mm, to effect liquid-liquid extraction of hydrogen peroxide from the organic solution into the aqueous medium, and thereafter separating the aqueous medium containing extracted hydrogen peroxide from the H₂O₂-depleted organic solution to obtain a H₂O₂-containing aqueous solution

A preferred embodiment of this invention comprises two or more channeled devices connected in a series of stages, in which the separation of H₂O₂-containing aqueous medium from organic solution is effected in each stage and the overall relative flow of aqueous medium and organic solution between stages is in a countercurrent direction.

Another preferred embodiment of the invention is a method for the recovery of hydrogen peroxide produced in an anthraquinone auto-oxidation process comprising contacting a H₂O₂-containing organic work solution in an auto-oxidation process with an aqueous extraction medium in a microchannel extraction device with elongated channels having at least one cross sectional dimension within the range of from about 5 microns to about 5 mm, to effect liquid-liquid extraction of hydrogen peroxide from the organic work solution into the aqueous medium, and thereafter separating the aqueous medium containing extracted hydrogen peroxide from the H₂O₂-depleted organic work solution to obtain a H₂O₂-containing aqueous solution

Still another preferred embodiment of the invention is the recovery of hydrogen peroxide produced in an anthraquinone auto-oxidation process comprising contacting a H₂O₂-containing organic work solution in an auto-oxidation process with an aqueous extraction medium in a plate fin extraction device with elongated channels having at least one cross sectional dimension within the range of from about 0.5 mm to about 5 mm, to effect liquid-liquid extraction of hydrogen peroxide from the organic work solution into the aqueous medium, and thereafter separating the aqueous medium containing extracted hydrogen peroxide from the H₂O₂-depleted organic work solution to obtain a H₂O₂-containing aqueous solution

### BRIEF DESCRIPTION OF THE DRAWING

FIG. 1 illustrates a multistage extraction in a preferred embodiment of the method of this invention having five stages, each stage having a small channel device A and associated separator B for separating the two phase mixture exiting from the device A.

### DESCRIPTION OF THE PREFERRED EMBODIMENTS

The present invention is directed to the liquid-liquid extraction of aqueous hydrogen peroxide from an auto-oxidation process, where the extraction is carried out in a device with elongated channels or passageways having a relatively small cross-sectional dimension. The small or narrow channels of the extraction device provide a high surface-to-volume ratio, good intermixing of two phase extraction mixture, and enhanced mass transfer of the hydrogen peroxide from the organic phase into the aqueous phase, all of which provide unexpected efficiencies and advantages to the extractive recovery of hydrogen peroxide.

The small channel extraction devices of this invention are those have at least one channel cross-sectional dimension that is less than about 5 mm and more preferably, less than about 3 mm. The extraction device utilized in the liquid-liquid extraction method of this invention is passive and does not require moving mechanical parts, a factor that minimizes maintenance costs. Small channel devices that are preferred for use in the present invention include so-called microchannel devices and plate fin devices, both of which are conventionally used as heat exchangers or reactors for gases, liquids and combinations of liquids and gases.

The present invention provides several unexpected advantages in the liquid-liquid extraction of hydrogen peroxide, as compared with the conventional sieve tray extraction columns used in commercial hydrogen peroxide production facilities. The small channel extraction devices of this invention provide higher extraction efficiencies than conventional sieve tray columns. The channeled devices of this invention are capable of single stage extraction efficiencies in excess of 80% or even 90% of theoretical equilibrium, in contrast to conventional sieve tray extraction columns that typically only achieve about 20-50% of theoretical equilibrium (of hydrogen peroxide distribution from the work solution into the aqueous phase) in a single sieve trays (or plate), i.e., a single stage). While not wishing to be bound by any particular theory or mechanism, the inventors believe that the small channel dimensions in the extraction devices of this invention promote good intermixing and intimate contact of the two liquid phases, enhancing the rate of mass transfer of hydrogen peroxide from the organic phase into the aqueous medium extract phase.

The liquid-liquid extraction carried out in the small channel devices of this invention permits precise temperature control, because of the heat transfer capabilities of these devices. Extraction temperatures can not only be maintained at a constant temperature but can also be varied at different regions or locations, to optimize the distribution of hydrogen peroxide into the aqueous extract.

The extraction method of this invention is particularly adapted to recovery of aqueous hydrogen peroxide in cyclic auto-oxidation processes, not only large scale processes but also medium and small scale hydrogen peroxide production facilities. The present invention has the advantage of effecting significant economic and process efficiencies in existing large scale hydrogen peroxide production technologies, as is described in this specification.

### Other Preferred Embodiments

One preferred embodiment of the extraction method of this invention permits the extraction to be carried out concurrently with the auto-oxidation of hydrogenated working solution, in the channeled devices of this invention. A hydrogenated work solution is introduced into a channeled device of this invention, along with the introduction of an oxidizing agent, e.g., air, oxygen or an oxygen-containing gas, and an aqueous extraction medium, e.g. water, to generate in situ the H₂O₂-containing organic work solution via an auto-oxidation reaction and concurrently effect extraction of the H₂O₂ from the organic work solution into the aqueous medium. The combination of these unit operations (auto-oxidation and extraction) into a single device provides significant economic advantages, as compared with the separate unit operations employed in current commercial practice.

The extraction method of the present invention may optionally be used in conjunction with conventional hydrogen peroxide extractions carried out in sieve tray columns or other conventional liquid-liquid extraction columns, (i) by treating H₂O₂-depleted organic work solution obtained as effluent at the top of the column, in a supplemental or further extraction step, using fresh aqueous medium and then introducing the aqueous extract into the extraction column, or (ii) by treating H₂O₂-containing organic work solution prior to its introduction as feed at the bottom of the column, in an initial extraction step using aqueous extract obtained from the bottom of the column as the aqueous medium to obtain an aqueous extract product stream with an increased hydrogen peroxide concentration.

In one embodiment, the channeled device is used in combination with a conventional liquid-liquid extraction column in an anthraquinone auto-oxidation process to effect additional extraction of residual hydrogen peroxide from H₂O₂-depleted organic work solution obtained as effluent from the top of the extraction column, using fresh aqueous medium and then introducing the resulting aqueous extract into the extraction column. This embodiment reduces the amount of residual hydrogen peroxide in the H₂O₂-depleted organic work solution that has been subjected to extraction in the column, and this supplemental extraction thus improves the overall recovery efficiency of hydrogen peroxide from the organic work solution.

In another embodiment of the method of this invention, the channeled device of this invention is used in combination with a conventional liquid-liquid extraction column in an anthraquinone auto-oxidation process to effect additional extraction of hydrogen peroxide from the H₂O₂-containing organic work solution obtained from the auto-oxidation step and prior to its introduction as feed at the bottom of the column, using aqueous extract obtained from the bottom of the column as the aqueous medium to obtain an aqueous extract product stream with an increased hydrogen peroxide concentration. This second embodiment serves to increase the concentration of hydrogen peroxide in the recovered aqueous extract solution stream, since the channeled extraction device of this invention typically provides a hydrogen peroxide concentration in the aqueous extract of at least 90% of the theoretical distribution amount.

### Extraction Device Characteristics

The small channel extraction device of this invention is characterized by having one or more small dimension or narrow cross-section channels or passageways that provide a flow path for the two phase extraction mixture, namely, the aqueous extraction medium being contacted with the H₂O₂-containing organic solution.

Suitable small channel extraction devices contain flow channels or pathways with at least one cross sectional dimension in the range of about 5 microns up to about 5 millimeters (mm), more preferably, up to about 3 mm. The small channels are normally elongated, i.e., they are not perforations in a plate, and are longitudinal in configuration. The elongated or longitudinal dimension of channels is at least ten times the size of the smallest cross sectional dimension. A small channel device may contain one or multiple small channels, as many as 10,000 small channels. The small channels may be linked, e.g. in series or in parallel or in other configurations or combinations.

The small channel extraction device contains at least one inlet, as an entrance for the joint or separate introduction of the aqueous extraction medium and H₂O₂-containing organic solution into the small channels within the device, and at least one exit, for withdrawal of the aqueous H₂O₂-containing extract and the H₂O₂-depleted organic solution (raffinate). The small channel configurations, e.g. multiple parallel channels within the extraction device, can be linked to one or more entrances and/or exits via manifold or header or distribution pathways, passageways or channels.

Large throughput volume flow rates may be obtained through the use of multiple channels in a single device, e.g., parallel channels within a single device, or through two or more single/multiple channel devices being connected in parallel, or combinations of these approaches, to provide the desired volumetric throughput.

The aqueous medium may be introduced into the extraction device in admixture with or concurrently with the introduced H₂O₂-containing organic solution or separately, via a separate inlet that connects directly or indirectly with one or more channels carrying the introduced organic solution. In situations where the aqueous medium is introduced into the small channel extraction device in admixture with H₂O₂-containing organic solution, the two combined phases may optionally be subjected to a preliminary mixing step. Such a premixing step, prior to the two phases being introduced into the extraction device, can promote contact and dispersion of the two phases such that overall extraction efficiency in the small channel extraction device is improved.

In addition, the small channel extraction device may contain other process control aspects besides inlet(s) and exit(s), such as valves, mixing means, separation means, flow redirection conduit lines, that are in or a part of the small channel device system. The small channel device may also contain heat exchange and heat flux control means, such as heat exchange conduits, chambers or channels, for the controlled removal or introduction of heat to or from the organic solution and/or aqueous medium and/or two phase extraction mixture flowing through the channel network. The small channel extraction device may also contain process control elements, such as pressure, temperature and flow sensors or control elements.

The small channel cross section maybe any of a variety of geometric configurations or shapes. The small channel cross section may be rectangular, square, trapezoidal, circular, semi-circular, sinusoidal, ellipsoidal, triangular, or the like. In addition, the small channel design may contain wall extensions or inserts that modify the cross-sectional shape, e.g., fins, etc. The shape and/or size of the small channel cross section may vary over its length. For example, the height or width may taper from a relatively large dimension to a relatively small dimension, or vice versa, over a portion or all of the length of the small channel flow path.

The small channel extraction device may employ single or, preferably multiple, flow path small channels with at least one cross sectional dimension within the range of from about 5 microns to 5 mm, preferably 10 microns to 3 mm, and most preferably 50 microns to 3 mm. Preferably, the diameter or largest cross sectional channel dimension (height or width or other analogous dimension in the case of non-circular cross-sectioned microchannels) is not larger than 5 cm and more preferably not larger than 3 cm, and most preferably not larger than 2 cm.

It should be recognized that the small channel network may have channels whose dimensions vary within these ranges over their length and, further, that these preferred dimensions are applicable to the channel sections of the device where the extractive mass transfer of hydrogen peroxide from the organic solution to the aqueous medium is carried out.

Fluid flow through the small channels is generally in a longitudinal direction, approximately perpendicular to the cross-sectional channel dimensions referred to above. The longitudinal dimension for the small channel is typically within the range of about 3 cm to about 10 meters, preferably about 5 cm to about 5 meters, and more preferably about 10 cm to about 3 meters in length. The minimum length of the channels is at least ten times the dimension of the smallest cross sectional dimension of a channel, but the typical channel length is normally significantly longer than this minimum length.

The channels in the extraction device microreactor may also include inert packing, e.g., glass beads or the like, in sections of the small channel device to improve the mixing and mass transfer of hydrogen peroxide between the two extraction phases.

The selection of small channel dimensions and overall length is normally based on the residence time desired for the aqueous medium in contact with the H₂O₂-containing organic solution in the small channel extraction device and on the contact time desired for two phase system, the organic phase (work solution) and the aqueous phase (aqueous extraction medium).

The residence time is preferably selected to achieve a distribution of hydrogen peroxide between the aqueous phase (aqueous extraction medium) and the organic phase (work solution) that is at least about 80%, and more preferably at least about 90%, of the partition or distribution coefficient (also known as K value) of hydrogen peroxide between the two phases. The partition or distribution coefficient (K value) is defined as the ratio of the concentration of H₂O₂ in the aqueous phase to that in the organic phase when the two phases are in direct contact and the distribution of H₂O₂ between them has reached a thermodynamic equilibrium.

The channeled devices of the present invention thus have the advantage of providing very high single stage extraction efficiencies, in excess of 80% or even 90% of theoretical equilibrium (of hydrogen peroxide distribution from the work solution into the aqueous phase).

A preferred embodiment of the invention is two or more devices connected in a series of stages, to provide multiple extraction stages, each having a channeled device and associated liquid-liquid separator. The number of stages may be a few as two or three. Multistage extractions can be carried out with more than three stages, e.g. 4, 5, 6, 7 or 8 or more stages. The overall flow between stages is in a countercurrent direction.

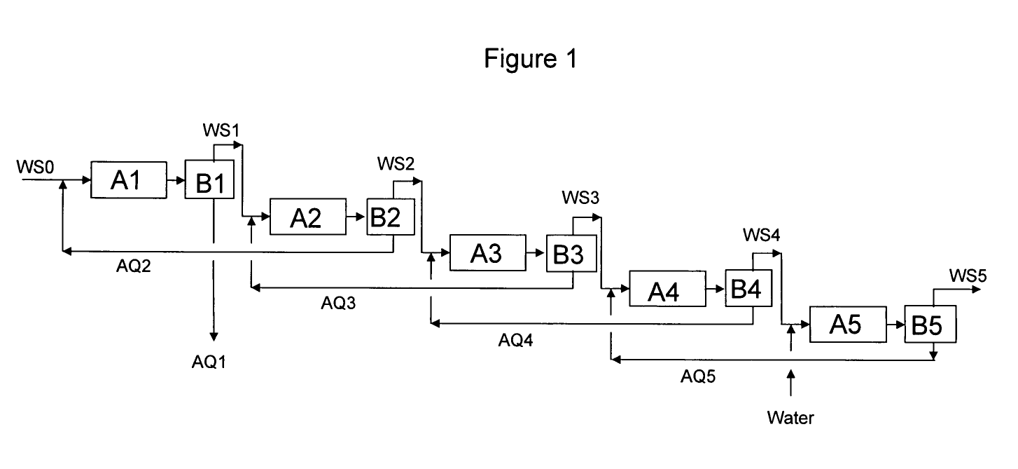

FIG. 1 illustrates a multistage extraction in a preferred embodiment of the method of this invention having five stages, each with a small channel device A and associated separator B for separating the two phase mixture exiting from the device A, and the overall flow between stages being in a countercurrent direction. The organic solution streams are labeled WS, and the aqueous medium streams are labeled AQ.

In FIG. 1, the feed stream WS0 of H₂O₂-containing organic work solution is introduced onto the first stage A1 and contacted there with an aqueous medium extract stream AQ2 obtained from the second stage separator B2. The feed stream of fresh aqueous medium (labeled “water”) is introduced into the final stage A5 of the five multiple stage operation shown in FIG. 1 and is contacted there with an organic work solution raffinate stream WS4 from the penultimate stage 4.

Intermediate stages in multistage operation with three or more stages are operated in a fashion similar to that shown in FIG. 1, with the organic solution feed for each intermediate stage being the raffinate stream separated and obtained from the previous (upstream) stage and the aqueous medium extract stream being the aqueous extract separated and obtained from the separation step in the next adjacent (downstream) stage. Multistage extraction operations have the advantage of providing very high hydrogen peroxide concentrations in the recovered aqueous hydrogen peroxide extract solution, e.g. stream AQ1 in FIG. 1.

A single stage in the method of this invention can readily provide 15-25 wt % H₂O₂ in the recovered aqueous hydrogen peroxide extract solution. Concentrations of 30-35 wt % H₂O₂ in the recovered aqueous hydrogen peroxide extract solution may be obtained with multiple stages. In situations where the preferred multistage embodiment of this invention is employed, overall extraction recovery of hydrogen peroxide can be in excess of 95%, and even at least 98% or 99%, based on the amount of hydrogen peroxide in the organic solution subjected to the inventive extraction method.

The small channel extraction device can be fabricated or constructed from a variety of materials, using any of many known techniques adapted for working with such materials. The small channel extraction device may be fabricated from any material that provides the strength, dimensional stability, inertness and heat transfer characteristics that permit the extraction of hydrogen peroxide to be carried out as described in this specification. Such materials may include metals, e.g. aluminum, steel (e.g., stainless steel, carbon steel, and the like), monel, inconel, titanium, nickel, platinum, rhodium, chromium, and their alloys; polymers (e.g., thermoset resins and other plastics) and polymer composites (e.g., thermoset resins and fiberglass); ceramics; glass; fiberglass; quartz; silicon; graphite; or combinations of these.

The small channel extraction device may be fabricated using known techniques including wire electrodischarge machining, conventional machining, laser cutting, photochemical machining, electrochemical machining, molding, casting, water jet, stamping, etching (e.g., chemical, photochemical or plasma etching) and combinations thereof. Fabrication techniques used for construction of the small channel extraction device are not limited to any specific methods, but can take advantage of construction techniques known to be useful for construction of a device containing small dimension internal channels or passageways, i.e., microchannels. For example, microelectronics technology applicable for creation of microelectronic circuit pathways is applicable where silicon or similar materials are used for construction of the microreactor. Metal sheet embossing, etching, stamping or similar technology is also useful for fabrication of a microreactor from metallic or non-metallic sheet stock, e.g. aluminum or stainless steel sheet stock. Casting technology is likewise feasible for forming the component elements of a small channel device.

The small channel device may be constructed from individual elements that are assembled to form the desired channeled configuration with an internal individual channels or interconnected channel network. The small channel device may be fabricated by forming layers or sheets with portions removed that create channels in the finished integral device that allow flow passage to effect the desired mass transfer during the two phase liquid-liquid-extraction of hydrogen peroxide. A stack of such sheets may be assembled via diffusion bonding, laser welding, diffusion brazing, and similar methods to form an integrated device. Stacks of sheets may be clamped together with or without gaskets to form an integral device. The channeled extraction device may be assembled from individual micromachined sheets, containing small channels, stacked one on top of another in parallel or perpendicular to one another to achieve the channel configuration desired to achieve the sought-after production capacity. Individual plates or sheets comprising the stack may contain as few as 1, 2 or 5 small channels to as many as 10,000.

Preferred small channel device structures employ a sandwich-like arrangement containing a multiple number of layers, e.g., plates or sheets, in which the channel-containing various layers can function in the same or different unit operations. The unit operation of the layers can vary from reaction, to heat exchange, to mixing, to separation or the like.

One type of small channel device preferred for use in the liquid-liquid extraction method of this invention is the so-called microchannel or microreactor device. Such microchannel devices have been described in numerous patents issued to Battelle Memorial Institute and Velocys Inc. (Plain City, Ohio). The disclosures of U.S. Pat. No. 7,029,647 of Tonkovich et al. that relate to microchannel devices are hereby incorporated by reference into the present specification, as examples of microchannel devices that could be adapted for use in the liquid-liquid extraction method of the present invention.

Other small channel heat exchanger devices have also been disclosed in the patent literature that have applicability in the extraction method of this invention. The disclosures of U.S. Pat. No. 7,111,672 and No. 6,968,892, both of Symonds and assigned to Chart Heat Exchangers Ltd, are hereby incorporated by reference into the present specification, for their descriptions of small channel heat exchanger and fluid mixing devices of the “fin-pin” type that can be fabricated with small channels, including microchannels, to create a small channel device that may be adapted for use in the liquid-liquid extraction method of the present invention.

Likewise, U.S. Pat. No. 6,736,201, of Watton et al. and assigned to Chart Heat Exchangers Ltd., is hereby incorporated by reference into the present specification, for its descriptions of small channel heat exchanger and fluid mixing devices having bonded stacks of perforated plates that can be fabricated with small channels, including microchannels, to create a small channel device that may be adapted for use in the liquid-liquid extraction method of the present invention.

Another type of small channel heat exchanger device preferred for use in the liquid-liquid extraction method of this invention is the so-called plate fin heat exchanger. The fabrication standards for such plate-fin heat exchangers are described in the Brazed Aluminium Plate-Fin Heat Exchanger Manufacturers' Association's (ALPEMA's) “The Standards of the Brazed Aluminium Plate-Fin Heat Exchanger Manufacturers' Association”, second edition, 2000, pp. 1-70, available on the internet at http://www.alpema.org/stand.htm. Plate-fin devices suitable for use in this invention are manufactured by Chart Energy & Chemicals Inc., La Crosse, Wis. (www.chart-ind.com/app_ec_heatexchangers.cfm).

Conventional plate-fin heat exchangers are typically fabricated by stacking alternate layers of aluminum parting sheets and corrugated fin stock that are brazed into a laminate structure. The number of individual small dimension passageways will typically range from a few dozen to hundreds or more, depending on the size of the unit and number of laminates. The sides and ends of the stack are sealed with sheets known as side and end bars. Individual or multiple inlets are provided, as are outlets, and these are normally connected, e.g., via a manifold, to internal distribution passageways that direct the introduced and withdrawn fluid to and from the small dimension channels or pathways formed by the corrugated fin stock.

The plate fin extraction devices may be constructed using relatively thin parting sheets, e.g., preferably having a thickness ranging from about 0.25 mm to about 2 mm, and more preferably about 1 mm to about 1.5 mm. It should be apparent that the thickness of the parting sheets does not directly impact the dimensions of the channels formed by the fins sandwiched between the parting sheets.

The corrugated fins are sandwiched between the parting sheets, to form channels for fluid flow. The corrugated fins can be fabricated in a variety of designs, e.g. straight and continuous, herringbone (wavy) or serrated shapes. The corrugated fins can contain perforations or other openings that allow contact between the liquid streams flowing in adjacent channels. The straight and straight-perforated fins have the lowest pressure drop associated with their configuration, and the serrated and herringbone designs have higher pressure drops associated with their more complex flow paths.

The dimensions of the fin height, i.e., the spacing between the parting sheets, may range from about 1 mm to about 20 mm or more, with about 2 mm to about 15 mm being preferred.

The spacing between fins (fin pitch, measured as the distance from a fin surface across the fin void through the adjacent fin to the corresponding adjacent fin far surface; fin pitch thus includes the gap between adjacent fins and the wall thickness of one fin.) may also be varied over a wide range, e.g. from about 0.8 mm to about 20 mm or more, with about 1 mm to about 15 mm [about 0.04 in. to about 0.6 in.] being preferred. Fin spacing also be expressed as fins per inch, calculated as [1 in./fin pitch (in inches)], so a fin pitch of 0.040 in. (1 mm) corresponds to 25 fins per inch.

The thickness of the sheet material used to form the fins is relatively thin, e.g. preferably having a thickness ranging from about 0.15 mm to about 0.8 mm.

The channels in a plate fin extraction device may be longitudinal, or with angled or U-shaped bends, to redirect the flow of the fluid within the device. An example of such channel pathways is shown in the plate-fin heat exchanger illustrated in U.S. Pat. No. 4,473,110 of Zawierucha, which is hereby incorporated by reference for its disclosures about the construction of plate fin heat exchangers.

When a plate fin heat exchanger is adapted for use as an extraction device in the method of this invention, the heat exchange channels in the plate fin device may optionally be used to provide heat transfer and temperature control of the two phase mixture introduced into the extraction device.

### Composition of Aqueous Extraction Medium

The aqueous extraction medium is preferably water and more preferably demineralized or deionized water. Demineralized water lacks mineral impurities (usually present in ionized form) that can lead to degradation of the hydrogen peroxide in the aqueous extract recovered from the extraction operation.

The aqueous medium may also contain other components, particularly those used to adjust the pH of the aqueous medium or stabilize the extracted hydrogen peroxide against degradation or decomposition.

The pH of the aqueous medium may be neutral or slightly acidic. In situations where an acidic pH is desired, the pH of the aqueous medium is preferably adjusted to a pH below 6 and more preferably within the pH range of about 2to about 4.

The acidic pH of the aqueous medium may be adjusted or controlled via the addition of acids, preferably those acids that are highly soluble in water but relatively insoluble in the organic working solution. Suitable acids for pH adjustment include, e.g., phosphoric acid, nitric acid, hydrogen chloride, sulfuric acid or the like; salts of acids may also be used, e.g. sodium dihydrogen phosphate. Phosphoric acid and phosphate salts are preferred since they also act as a stabilizer for the hydrogen peroxide in the aqueous extract.

### Composition of Organic Solution (Work Solution)

The H₂O₂-containing organic solution that is obtained from the oxidation step in the AO hydrogen peroxide process contains hydrogen peroxide in relatively dilute concentrations, e.g. e.g., at least about 0.3 wt % H₂O₂, preferably at least about 0.5 wt % to about 2.5 wt % H₂O₂.

The hydrogen peroxide-containing organic solution, preferably a H₂O₂-containing work solution obtained in an anthraquinone AO process, is employed as the organic solution feed that is introduced into the liquid-liquid extraction method of the present invention, as described in this specification.

In the event that the extraction method of this invention is used in a commercial anthraquinone AO process as a supplemental extraction step, following a conventional liquid-liquid column extraction, the effluent organic work solution raffinate stream from the liquid-liquid extraction column used as the organic work solution feed in the extraction of this invention will have had its H₂O₂ content substantially depleted by the extraction already carried out in the extraction column. Such an organic work solution raffinate stream will contain hydrogen peroxide at very dilute concentrations, e.g., about 0.01 wt % H₂O₂ to about 0.1 wt % H₂O₂.

Concentrations of hydrogen peroxide in the work solutions of anthraquinone AO processes are typically in the range of about 0.8 wt % to about 1.5 wt % H₂O₂. The concentration of hydrogen peroxide in the work solution will of course depend on the composition of work solution (anthraquinone working compounds and organic solvent compositions employed) as well as the operating conditions of the oxidation unit operation.

The compositions of suitable AO process working compounds and work solutions are discussed further below.

### Relative Amounts of Aqueous Medium and Organic Solution Employed in Extraction

In the small channel extraction device of this invention, the H₂O₂-containing organic solution and the aqueous extraction medium preferably flow in a concurrent direction, as the two phases become intermixed. The aqueous extraction medium is preferably the liquid phase dispersed throughout the organic solution, in the two phase liquid-liquid mixture that is flowed through the small channels.

Extraction occurs when the hydrogen peroxide in the organic solution migrates (diffuses) into the aqueous phase. The inventors believe that overall extraction efficiency is generally improved in the small channel devices of this invention when the aqueous extraction medium is the dispersed phase, while the H₂O₂-containing work solution is the continuous phase. This is in sharp contrast to the situation in conventional sieve tray extraction columns, where the H₂O₂-containing work solution is the dispersed phase and the aqueous extraction medium is the continuous phase.

The distribution coefficient for hydrogen peroxide between the organic solution, e.g., work solution (organic phase) and the aqueous medium (aqueous phase) favors concentration of the hydrogen peroxide in the aqueous phase. The relative amount of organic solution introduced to the extraction operation is normally in substantial excess over the amount of aqueous medium, although the two may also be used in equivalent amounts. The volume ratio of organic solution (organic phase) to aqueous medium (aqueous phase) may range from about 1:1 to 100:1, with preferred ratios ranging from about 10:1 to about 60:1. For multistage operation, the preferred volume ratio of organic solution to aqueous medium may range from about 30:1 to about 70:1.

The contact time (residence time) between the organic solution and the aqueous medium in the liquid-liquid extraction device should be sufficient to provide for the extraction mass transfer to reach at least 80%, and more preferably 90%, of the distribution coefficient or partition coefficient (i.e., K value) for hydrogen peroxide distributed between the aqueous extraction medium and the organic solution. In addition, the flow rate through the extraction device should be sufficient to ensure good mixing of the two phases in the extraction device channels.

The contact time of the two phases in the extraction device will normally be in the range of seconds or minutes, rather than hours. The contact time will depend on the design parameters of the channels (length and cross-sectional dimensions) in the extraction device, flow mixing of the two phases, and temperature of the two phases (higher extraction temperatures promote more rapid extraction of the hydrogen peroxide into the aqueous medium and increase the distribution of hydrogen peroxide in the aqueous phase).

The residence time of the two phase mixture in the extraction device may range from a few seconds, e.g. about 1-300 seconds, to several minutes, e.g., about 5-30 minutes, or longer. Preferred residence times are less than 5 minutes and, more preferably, less than 2 minutes.

The two liquid-liquid phases withdrawn from the channeled device are normally a mixture of the two phases and are therefore subsequently separated, into (i) an organic solution raffinate stream or phase, depleted in its hydrogen peroxide concentration, and (ii) an aqueous medium extract stream or phase, containing hydrogen peroxide extracted from the organic phase. It is also possible to carry out this separation while the two intermixed phases are still in the small channel device, by providing a region in the small channel device that effects separation of the mixed phases into two distinct phases, such as a quiescent coalescing zone downstream of the extraction channels for effecting separation of the aqueous medium extract from the organic solution, prior to their withdrawal from the device.

### Extraction Temperature and Pressure

Operating temperatures for the small channel extraction device are generally equal to or higher than the temperatures normally employed for conventional large-scale extractions carried out in sieve plate extraction columns. The enhanced process extraction efficiencies and improved mass and heat transfer achievable with the method of the present invention permit higher operating temperatures to be used without compromise in the overall process efficiency.

Excellent temperature control is achieved in the small channel extraction device of this invention, and near isothermal operation is feasible. Such temperature control is normally achieved via heat exchange channels (which may be microchannels or larger dimension passgeways) located adjacent to the small channels carrying the extraction mixture, through which heat exchange channels a heat exchange fluid is flowed.

The extraction in the method of this invention may be carried out over a wide range of operating temperatures. The extraction operation temperature may be at a single temperature or multiple temperatures within the range of about 10° C. to about 90° C. Preferred extraction temperatures are within the range of about 30° C. to about 70° C.

Extraction at temperatures above about 90° C. is feasible but use of such high extraction temperatures is discouraged by the increased likelihood of hydrogen peroxide decomposition, particularly above 70° C. Extraction temperatures below about 10° C. are feasible but are not favored since cooling of the aqueous medium and organic phase below 15° C. is not only expensive but also requires reheating of H₂O₂-depleted work solution recovered from the extraction operation, prior to the subsequent hydrogenation operation which is typically carried out at elevated temperatures. Another drawback associated with use of extraction temperatures below 15° C. is that the working compounds may precipitate and separate from the work solution.

Operating pressures for the small channel extraction device, generally measured as the exit pressure, are typically in the low to moderate range, high pressure operation being unnecessary and not warranted from an economic standpoint. Operating pressures are normally less than the pressure used in the auto-oxidation step (the preceding unit operation) and are preferably in the range of about atmospheric pressure to about 60 psig.

### Separation of Aqueous Extract and Organic Solution Raffinate

The liquid stream recovered from the small channel extraction device is normally a liquid-liquid mixture containing (i) an aqueous extract phase, containing the extracted hydrogen peroxide, and (ii) an organic solution raffinate, substantially depleted of its original hydrogen peroxide content. This two phase mixture is subjected to a separation step, typically in a conventional liquid-liquid separator, to effect separation of the two phase mixture into an aqueous extract phase and an organic solution raffinate. Conventional coalescers are preferred, but other liquid/liquid separators, e.g. gravity separators, centrifugal separators or hydroclones, can also be used.

The organic solution raffinate obtained from the separation operation typically contains very little or no entrained droplets of aqueous extraction solution. Any residual aqueous extract in the work solution raffinate is normally removed in a subsequent drying operation, with the hydrogen peroxide contained in the aqueous extract being lost. However, such process losses are normally minimized by judicious selection of effective and efficient separation techniques and equipment, e.g. conventional coalescers, gravity separators, centrifugal separators or hydroclones, as previous mentioned.

Since any hydrogen peroxide remaining in the residual aqueous extract in the raffinate work solution is destroyed in the drying and subsequent processing steps, minimization of such residual aqueous extract is important to the overall economics of the process.

The aqueous hydrogen peroxide solution recovered as separated aqueous extract, in preferred multistage embodiments of the extraction method of this invention, contains at least about 90%, and more preferably, at least about 95% and most preferably, at least about 98%, of the hydrogen peroxide content originally present in the work solution introduced to the extraction operation. The recovered organic solution stream, obtained as the separated organic solution raffinate in preferred multistage extraction embodiments of this invention, is substantially depleted of its original hydrogen peroxide content. The recovered organic solution stream is normally recycled for reuse in the hydrogenation step of an AO process.

The concentration of aqueous hydrogen peroxide solution recovered in the extraction method of this invention can vary over wide concentration ranges, being as low as about 1 wt % H₂O₂ or as high as about 60 wt % H₂O₂. The concentration of hydrogen peroxide in the aqueous extract recovered from a single stage extraction operation in this invention can range from about 1 wt % to about 25 wt % H₂O₂ or more. Multistage operation can provide hydrogen peroxide concentration in the same range as for a single stage but at higher overall recovery efficiencies. In addition, multistage operations can be used to obtain concentrated aqueous hydrogen peroxide solutions, the hydrogen peroxide concentration in the aqueous extract solution having at least about 15 wt % H₂O₂. Hydrogen peroxide concentration in multistage extraction operations in the method of this invention are preferably at least about 20 wt % H₂O₂, more preferably at least about 25 wt % H₂O₂, and most preferably at least about 30 wt % H₂O₂ or higher.

The hydrogen peroxide concentration actually obtained or obtainable will depend on the concentration actually needed or desired for a specific end use application and on process operating parameters, such as whether a single stage or multiple stages are used, the relative amount of H₂O₂-containing organic work solution contacted with aqueous extraction medium, the chemical and physical nature of the working compound and work solution, the initial concentration of H₂O₂ in the H₂O₂-containining organic work solution, the overall hydrogen peroxide recovery efficiency desired and other like factors.

For any assumed (or desired) hydrogen peroxide concentration in the recovered aqueous extract solution and desired overall hydrogen peroxide recovery efficiency, the number of stages in a multistage operation can readily be determined for a given set of operating parameters. The fact that the individual extraction stages normally yield an aqueous extract containing at least 90% of the theoretical distribution of hydrogen peroxide between the organic and aqueous phases makes the calculation of number of stages relatively straightforward.

Concentrations of hydrogen peroxide of at least about 30 wt % H₂O₂ in the recovered aqueous solution are preferred since most commercial grades of hydrogen peroxide currently offered are at 30-35 wt % and higher. Currently-offered commercial grades of hydrogen peroxide in excess of about 30-35 wt % H₂O₂ normally require additional concentration steps, e.g. distillation, to yield 50 wt % or 70 wt % H₂O₂ grades.

The aqueous extract containing the hydrogen peroxide product is normally cooled after its recovery from the extraction step, if the extraction operation is carried out at elevated temperatures, e.g. above about 30° C.

The aqueous hydrogen peroxide solution recovered in the extraction method of this invention may be treated with inhibitors or stabilizers to minimize decomposition or degradation of the hydrogen peroxide. The aqueous hydrogen peroxide solution may also be concentrated further, if desired, via conventional vacuum distillation.

The recovered organic solution raffinate contains the working compound in a reformed or regenerated form (following auto-oxidation), and the working compound in the organic solution (e.g., work solution) is recycled to the hydrogenation step in an AO process. For example, in anthraquinone AO processes, the anthraquinone working compound, having been reduced to the corresponding anthrahydroquinone during hydrogenation, is converted back to the original anthraquinone in the auto-oxidation step. The reformed working compound is then recycled back to the hydrogenation step, for reuse in the cyclic AO process, after the liquid-liquid extractive recovery of the hydrogen peroxide product according to the method of this invention.

### AO Processes: Anthraquinone Derivative—Working Compound & Work Solution

The hydrogen peroxide extraction method of this invention is applicable to a variety of H₂O₂ auto-oxidation processes. The extraction method is particularly useful for AO processes that use various known “working compounds” (i.e., “reactive compounds”) and “work solutions” containing such working compounds in the preparation of hydrogen peroxide via hydrogenation and subsequent auto-oxidation of the working compound.

The working compound is preferably an anthraquinone derivative. The anthraquinone derivative used as the working compound in the method of this invention is not critical and any of the known prior art anthraquinone derivatives may be used. Alkyl anthraquinone derivatives and alkyl hydroanthraquinone derivatives are preferred.

Alkyl anthraquinone derivatives suitable for use as the working compound in this invention include alkyl anthraquinones substituted in position 1, 2, 3, 6 or 7 and their corresponding alkyl hydroanthraquinones, wherein the alkyl group is linear or branched and preferably has from 1 to 8 carbon atoms. The alky group is preferably located on a position that is not immediately adjacent to the quinone ring, i.e., the 2-, 3-, 6-, or 7-position.

The extraction method of the present invention is applicable to AO processes that use, without limitation, the following anthraquinone derivatives: 2-amylanthraquinone, 2-methylanthraquinone, 2-ethylanthraquinone, 2-propyl- and 2-isopropylanthraquinones, 2-butyl-, 2-sec.butyl-, 2-tert.butyl-, 2-isobuytl-anthraquinones, 2-sec.amyl- and 2-tert.amylanthraquinones, 1,3-diethyl anthraquinone, 1,3-, 2,3-, 1,4-, and 2,7-dimethylanthraquinone, 1,4-dimethyl anthraquinone, 2,7-dimehtyl anthraquinone, 2 pentyl-, 2-isoamyanthraquinone, 2-(4-methyl-3-pentenyl) and 2-(4-methylpentyl) anthraquinone, 2-sec.amyl- and 2-tert.amyl-anthraquinones, or combinations of the above mentioned anthraquinones, as well as their corresponding hydroanthraquinone derivatives.

The anthraquinone derivative employed as the working compound may be chosen from 2-alkyl-9,10-anthraquinones in which the alkyl substituent contains from 1 to 5 carbon atoms, such as methyl, ethyl, sec-butyl, tert-butyl, tert-amyl and isoamyl radicals, and the corresponding 5,6,7,8-tetrahydro derivatives, or from 9,10-dialkylanthraquinones in which the alkyl substituents, which are identical or different, contain from 1 to 5 carbon atoms, such as methyl, ethyl and tert-butyl radicals, e.g. 1,3-dimethyl, 1,4-dimethyl, 2,7-dimethyl, 1,3-diethyl, 2,7-di(tert-butyl), 2-ethyl-6-(tert-butyl) and the corresponding 5,6,7,8-tetrahydro derivatives.

Particularly preferred alkylanthraquinones are 2-ethyl, 2-amyl and 2-tert.butyl anthraquinones, used individually or in combinations.

The “working compound” (reactive compound), e.g. anthraquinone derivatives being preferred, is preferably used in conjunction with a solvent or solvent mixture, the working compound and solvent(s) comprising a “work solution”.

It should be understood, however, that work solutions containing only a working compound, e.g., anthraquinone derivatives, are within the scope of the present invention. A solvent for the working compound(s) is preferred in the case of anthraquinone derivative working compounds but not essential for carrying out the liquid-liquid extraction in the method of this invention.

The solvent or solvent mixture used in the work solution preferably has a high partition coefficient for hydrogen peroxide with water, so that hydrogen peroxide can be efficiently extracted in the liquid-liquid extraction method of this invention. Preferred solvents are chemically stable to the process conditions, insoluble or nearly insoluble in water, and a good solvent for the anthraquinone derivative, e.g., alkylanthraquinone, or other working compound employed, in both their oxidized and reduced forms. For safety reasons, the solvent preferably should have a high flash point, low volatility, and be nontoxic.

Mixed solvents may be used and are preferred for enhancing the solubility of the (anthraquinone) working compound in both its hydrogenated (reduced) form (i.e., the hydroquinone form) and its oxidized (neutral) form (i.e., the quinone form.) The organic solvent mixture, forming part of the work solution, is preferably a mixture of a nonpolar compound and of a polar compound.

Since polar solvents tend to be relatively soluble in water, the polar solvent is desirably used sparingly so that water extraction of the oxidized work solution does not result in contamination of the aqueous hydrogen peroxide product in the aqueous extract. Nevertheless, sufficient polar solvent must be used to permit the desired concentration of the anthrahydroquinone to be present in the work solution's organic phase. The maintenance of a proper balance between these two criticalities is important in peroxide manufacture but is well known to those skilled in the art.

Solvent mixtures generally contain one solvent component, often a non-polar solvent, in which the anthraquinone derivative is highly soluble, e.g., C₈ to C₁₇ ketones, anisole, benzene, xylene, trimethylbenzene, methylnaphthalene and the like, and a second solvent component, often a polar solvent, in which the anthrahydroquinone derivative is highly soluble, e.g. C₅ to C₁₂ alcohols, such as diisobutylcarbinol and heptyl alcohol, methylcyclohexanol acetate, phosphoric acid esters, such as trioctyl phosphate, and tetra-substituted or alkylated ureas. Two or more of these polar solvents may be used together improve the solubility of anthrahydroquinone derivatives.

As noted earlier, the inert solvent system typically comprises a suitable anthraquinone and anthrahydroquinone solvent.

The solvent or solvent component for the anthraquinone derivative, e.g. alkylanthraquinone, is preferably a water-immiscible solvent. Such solvents include aromatic crude oil distillates having boiling points within the range of range of from 100° C. to 250° C., preferably with boiling points more than 140° C. Examples of suitable anthraquinone solvents are aromatic C₉-C₁₁ hydrocarbon solvents that are commercial crude oil distillates, such as Shellsol (Shell Chemical LP, Houston, Tex., USA), SureSol™ 150ND (Flint Hills Resources, Corpus Christi, Tex., USA), Aromatic 150 Fluid or Solvesso™ (ExxonMobil Chemical Co., Houston Tex., USA), durene (1,2,4,5-tetramethylbenzene), and isodurene (1,2,3,5-tetramethylbenzene).

Examples of suitable anthrahydroquinone solvents include alkylated ureas, e.g. tetrabutylurea, cyclic urea derivatives, and organic phosphates, e.g. 2-ethylhexyl phosphate, tributyl phosphate, and trioctyl phosphate. In addition, suitable anthrahydroquinone solvents include carboxylic acid esters, e.g. 2-methyl cyclohexyl acetate (marketed under the name Sextate), and C₄-C₁₂ alcohols, e.g., including aliphatic alcohols such as 2-ethylhexanol and diisobutyl carbinol, and cyclic amides and alkyl carbamates.

Alternatively, where all quinone systems are employed or other non-anthraquinone based auto-oxidation systems are employed in the method of this invention, the working compound may be employed without the use of a solvent.

### AO Processes: Non-Anthraquinone Systems

The extraction method of the present invention is also applicable to auto-oxidation production of hydrogen peroxide using working compounds other than anthraquinones. Although anthraquinone working compounds are preferred, the extraction method of this invention may be carried out for AO processes using non-anthraquinone working compounds conventionally used in large-scale hydrogenation and auto-oxidation production of hydrogen peroxide.

One example of such working compounds is azobenzene (and its derivatives), which can be used in a cyclic auto-oxidation process in which hydrazobenzene (1,2-diphenylhydrazine) is oxidized with oxygen to yield azobenzene (phenyldiazenylbenzene) and hydrogen peroxide, the azobenzene then being reduced with hydrogen to regenerate the hydrazobenzene. U.S. Pat. No. 2,035,101 discloses an improvement in the azobenzene hydrogen peroxide process, using amino-substituted aromatic hydrazo compounds, e.g., amino-substituted benzene, toluene, xylene or naphthalene.

Another example of such working compounds is phenazine (and its alpha-alkylated derivatives, e.g., methyl-1-phenazine), which also can be used in a cyclic auto-oxidation process in which dihydrophenazine is oxidized with oxygen to yield phenazine and hydrogen peroxide, the phenazine then being reduced, e.g., with hydrogen, to regenerate the dihydrophenazine. A phenazine hydrogen peroxide process is disclosed in U.S. Pat. No. 2,862,794.

The following non-limiting Example illustrates a preferred embodiment of the present invention.

### EXAMPLE

A work solution containing hydrogen peroxide, produced in an anthraquinone auto-oxidation process, is extracted in this Example in a plate fin extraction device to recover aqueous hydrogen peroxide.

The work solution is an organic solvent mixture of aromatic C₉-C₁₁ hydrocarbon solvent, trioctyl phosphate, and akylated urea, with the anthraquinone-derivative working compounds (reaction carrier) being 2-ethylanthraquinone and 2-ethyltetrahydroanthraquinone. The work solution is first subjected to hydrogenation with hydrogen gas in the presence of a palladium catalyst and then is subjected to auto-oxidation with air, to yield a work solution containing hydrogen peroxide concentration of 1.1 wt % H₂O₂.

The aqueous medium for the extraction procedure is deionized water containing sufficient phosphoric acid to adjust its pH value to about 3.

The proportions of H₂O₂-containing work solution and deionized water utilized in the extraction are about 40 parts by volume of work solution to 1 part by volume of water. The H₂O₂-containing work solution and deionized water are combined and introduced via a common inlet into a plate fin extraction device, with the extraction temperature being maintained at about 50° C.

The plate fin extractor is a brazed aluminum device with elongated straight channels with the following channel characteristics: fin type: plain; fin height of 4 mm; fin width (wall to wall) of 0.75 mm; fin thickness of 0.25 mm; and fin pitch of 1 mm. These fin dimensions result in about 25 fins per inch. The channel length is such to provide an internal volume within the channeled device of about 121 cm³.

The flow rate of the work solution introduced to the device is 600 ml/minute and the flow rate of the water is 15 ml/minute. This total flow rate of 615 ml/min provides a residence time in the channeled device of about 12 seconds for the two phase mixture.

The work solution and aqueous medium are well mixed within the internal channels that provide a passageway for the two phase extraction mixture in the extraction device, which effects transfer of hydrogen peroxide from the work solution into the aqueous phase such that at least 90% of a thermodynamic equilibrium is achieved.

The two phase extraction mixture that exits the plate fin extraction device is directed to a coalescing vessel, where the two phases become separated. The separated aqueous medium extract solution has a hydrogen peroxide concentration of about 22 wt % H₂O₂, and the separated H₂O₂-depleted work solution has a hydrogen peroxide concentration of about 0.4 wt % H₂O₂. The overall recovery of hydrogen peroxide in the aqueous extract in the single stage is about 60%, based on the hydrogen peroxide content of the organic work solution feed stream.

Higher hydrogen peroxide recovery efficiencies are obtained with the use of a multistage countercurrent-flow system, illustrated by the following three stage operation.

The operating parameters of the single stage unit described above are the same, with the following exceptions. Three units identical to the channeled device and coalescer described above are connected in series, with the overall flow of organic work solution and aqueous medium between units being in a countercurrent direction. The flow rate of deionized water (the aqueous medium) is increased to 30 ml/min (from 15 ml/min) but the flow rate of organic work solution remains the same at 600 ml/min. Residence time in each individual unit is still about 12 seconds.

In the first stage, the two phase extraction mixture that is obtained from the first stage extraction device is directed to a first stage coalescing vessel, where the two phases are separated. The aqueous phase that is recovered from this first stage is an aqueous hydrogen peroxide solution containing about 16 wt % H₂O₂. The separated organic solution stream from the first stage coalescer is introduced as organic solution feed to second stage extractor.

In the third stage, the two phase extraction mixture that is obtained from the third stage extraction device is directed to a third stage coalescing vessel, where the two phases are separated. The separated aqueous extract stream is redirected to and introduced into the second stage, where it is used as the aqueous medium that is contacted in the second stage with the organic work solution stream from the first stage.

The organic work solution that is recovered from the third stage is substantially depleted of its original hydrogen peroxide content and contains only about 0.03 wt % H₂O₂. The overall recovery of hydrogen peroxide in this three stage operation is 97%, based on the hydrogen peroxide content of the original organic work solution.

It will be appreciated by those skilled in the art that changes could be made to the embodiments described above without departing from the broad inventive concept thereof. It is understood, therefore, that this invention is not limited to the particular embodiments disclosed but is intended to cover modifications within the spirit and scope of the present invention as defined by the appended claims.

What is claimed is:

1. A method for the recovery of hydrogen peroxide produced in an auto-oxidation process comprising contacting a H₂O₂-containing organic solution in an auto-oxidation process with an aqueous extraction medium in a device with elongated channels having at least one cross sectional dimension within the range of from about 5 microns to about 5 mm, to effect liquid-liquid extraction of hydrogen peroxide from the organic solution into the aqueous medium, and thereafter separating the aqueous medium containing extracted hydrogen peroxide from the H₂O₂-depleted organic solution to obtain a H₂O₂-containing aqueous solution.

2. The method of claim 1 wherein the channeled device has at least one cross sectional dimension within the range of from about 50 microns to about 3 mm.

3. The method of claim 1 wherein the channeled device contains at least one inlet connecting one or more channels and an outlet connecting the channels, for respectively introducing the organic solution and aqueous medium into the extraction device and for removing a two phase liquid mixture from the extraction device.

4. The method of claim 1 wherein the channeled device further contains at least one additional passageway adjacent to at least one extraction channel for effecting heat transfer and temperature control during the extraction process using a heat transfer fluid in said at least one additional passageway.

5. The method of claim 1 wherein the channeled device comprises layered sheets that contain an interconnected channel network.

6. The method of claim 1 wherein the separation of the aqueous medium containing extracted hydrogen peroxide from the H₂O₂-depleted organic solution is carried out in a liquid-liquid separator selected from the group consisting of gravity settlers, coalescers, centrifugal separators, and hydroclones.

7. The method of claim 1 wherein the channeled device comprises a quiescent coalescing zone downstream of the extraction channels for effecting separation of the aqueous medium containing extracted hydrogen peroxide from the H₂O₂-depleted organic solution, prior to their withdrawal from the device.

8. The method of claim 1 which further comprises two or more channeled devices connected in a series of stages, in which the separation of H₂O₂-containing aqueous medium from organic solution is effected in each stage and the overall relative flow of aqueous medium and organic solution between stages is in a countercurrent direction.

9. The method of claim 1 wherein the aqueous medium contacted with the organic solution in the channeled device is selected from the group consisting of water, demineralized water and deionized water.

10. The method of claim 9 wherein the aqueous medium is adjusted to an acidic pH.

11. The method of claim 9 wherein the aqueous medium is adjusted to a pH value in the range of about 2 to about 6.

12. The method of claim 11 wherein the pH of the aqueous medium is adjusted by the addition of an acid or salt selected from the group consisting of phosphoric acid, nitric acid, hydrogen chloride, sulfuric acid, and phosphate salts.

13. The method of claim 1 wherein the organic solution comprises a working compound selected from the group consisting of amino-substituted aromatic azo compounds, phenazine, alkylated phenazine derivatives, alkyl anthraquinones, hydroalkyl anthraquinones, and mixtures of alkyl anthraquinones and hydroalkyl anthraquinones.

14. The method of claim 1 wherein the organic solution comprises an anthraquinone working compound carried in organic solvent.

15. The method of claim 14 wherein the anthraquinone working compound is selected from the group consisting of alkyl anthraquinones and hydroalkyl anthraquinones and mixtures of alkyl anthraquinones and hydroalkyl anthraquinones and the working compound is carried in a solvent mixture of (i) an aromatic C₉-C₁₁ hydrocarbon solvent and (ii) a second solvent component selected from the group consisting of alkylated ureas, cyclic urea derivatives, organic phosphates, carboxylic acid esters, C₄-C₁₂ alcohols, cyclic amides and alkyl carbamates and mixtures thereof.

16. The method of claim 1 which further comprises carrying out the auto-oxidation of a hydrogenated work solution in the channeled device with an oxidizing agent selected from the group consisting of air, oxygen and an oxygen-containing gas that is introduced into the device, concurrently with the extraction of the H₂O₂-containing organic work solution generated in situ by the auto-oxidation of hydrogenated work solution.

17. The method of claim 1 wherein the organic solution introduced into the channeled device contains at least about 0.3 wt % H₂O₂.

18. The method of claim 1 wherein the organic solution introduced into the channeled device contains from about 0.5 wt % to about 2.5 wt % H₂O₂.

19. The method of claim 1 wherein a single stage channeled device is used to obtain an aqueous H₂O₂-containing solution that contains from about 1 wt % H₂O₂ to about 25 wt % H₂O₂.

20. The method of claim 8 wherein the multiple stage channeled device contains at least two stages and is used to obtain an aqueous H₂O₂-containing solution that contains at least about 15 wt % H₂O₂.

21. A method for the recovery of hydrogen peroxide produced in an anthraquinone auto-oxidation process comprising contacting a H₂O₂-containing organic work solution in an auto-oxidation process with an aqueous extraction medium in a device with elongated channels having at least one cross sectional dimension within the range of from about 5 microns to about 5 mm, to effect liquid-liquid extraction of hydrogen peroxide from the organic work solution into the aqueous medium and thereafter separating the aqueous medium containing extracted hydrogen peroxide from the H₂O₂-depleted organic work solution to obtain a H₂O₂-containing aqueous solution.

22. The method of claim 21 wherein the channeled device is used in combination with a conventional liquid-liquid extraction column in an anthraquinone auto-oxidation process to effect additional extraction of hydrogen peroxide from the H₂O₂-containing organic work solution obtained from the auto-oxidation step and prior to its introduction as feed at the bottom of the column, using aqueous extract obtained from the bottom of the column as the aqueous medium to obtain an aqueous extract product stream with an increased hydrogen peroxide concentration.

23. The method of claim 21 wherein the channeled device is used in combination with a conventional liquid-liquid extraction column in an anthraquinone auto-oxidation process to effect additional extraction of residual hydrogen peroxide from H₂O₂-depleted organic work solution obtained as effluent from the top of the extraction column, using fresh aqueous medium and then introducing the resulting aqueous extract into the extraction column.

24. A method for the recovery of hydrogen peroxide produced in an anthraquinone auto-oxidation process comprising contacting a H₂O₂-containing organic work solution in an auto-oxidation process with an aqueous extraction medium in a microchannel device with elongated channels having at least one cross sectional dimension within the range of from about 5 microns to about 5 mm, to effect liquid-liquid extraction of hydrogen peroxide from the organic work solution into the aqueous medium and thereafter separating the aqueous medium containing extracted hydrogen peroxide from the H₂O₂-depleted organic work solution to obtain a H₂O₂-containing aqueous solution.

25. A method for the recovery of hydrogen peroxide produced in an anthraquinone auto-oxidation process comprising contacting a H₂O₂-containing organic work solution in an auto-oxidation process with an aqueous extraction medium in a plate fin device with elongated channels having at least one cross sectional dimension within the range of from about 0.5 mm to about 5 mm, to effect liquid-liquid extraction of hydrogen peroxide from the organic work solution into the aqueous medium and thereafter separating the aqueous medium containing extracted hydrogen peroxide from the H₂O₂-depleted organic work solution to obtain a H₂O₂-containing aqueous solution from the organic work solution.
